(19) United States
(12) Patent Application Publication
(10) Pub. No.: US 2017/0250627 A1
(43) Pub. Date: Aug. 31, 2017

(54) POWER GENERATOR

(71) Applicants: Sumitomo Riko Company Limited, Aichi (JP); PANASONIC INTELLECTUAL PROPERTY MANAGEMENT CO., LTD., Osaka (JP)

(72) Inventors: Koichi HASEGAWA, Aichi (JP); Takahiro KACHI, Aichi (JP); Kei KITAGAKI, Aichi (JP); Hidenori KATSUMURA, Osaka (JP); Hiroshi KAGATA, Osaka (JP); Hidenori OKUMURA, Osaka (JP)

(73) Assignees: Sumitomo Riko Company Limited, Aichi (JP); PANASONIC INTELLECTUAL PROPERTY MANAGEMENT CO., LTD., Osaka (JP)

(21) Appl. No.: 15/596,402

(22) Filed: May 16, 2017

Related U.S. Application Data
(63) Continuation of application No. PCT/JP2016/052427, filed on Jan. 28, 2016.

(30) Foreign Application Priority Data
Jan. 30, 2015 (JP) 2015-016580

(51) Int. Cl. H02N 2/18

(52) U.S. Cl. CPC H02N 2/188

(57) ABSTRACT

A power generator including: a first vibration system in which a first mass member is elastically supported by a first spring member; and a second vibration system in which a second mass member is elastically supported by a second spring member, the first and second vibration systems providing a multiple-degree-of-freedom vibration system. A power generating element disposed between the first and second mass members is configured to convert vibration energy input to the first vibration system and the second vibration system from a vibrating member to electrical energy. A resonance frequency of the first vibration system is a frequency lower than 1/√2 times a frequency of a vibration input to the first vibration system from the vibrating member. A loss factor of the first spring member of the first vibration system is at least 0.01 but not greater than 0.2.

### INCORPORATED BY REFERENCE

The disclosure of Japanese Patent Application No. 2015-016580 filed on Jan. 30, 2015 including the specification, drawings and abstract is incorporated herein by reference in its entirety. This is a Continuation of International Application No. PCT/JP2016/052427 filed on Jan. 28, 2016.

### BACKGROUND OF THE INVENTION

1. Field of the Invention

The present invention relates generally to a power generator that converts vibration energy of a vibrating member to electrical energy using a power generating element. More particularly, the present invention pertains to a power generator including a multiple-degree-of-freedom vibration system.

2. Description of the Related Art

In order to meet high demand for energy saving in recent times, attempts at vibration power generation have been made in which, in vibrating members such as an overpass or a bridge on a road, a vehicle, a body of a washing machine or the like, vibration energy is converted to electrical energy so as to be effectively utilized. An example of a power generator for realizing vibration power generation is the one shown in Japanese Unexamined Patent Publication No. JP-A-2014-011843 or the like that includes a two-degree-of-freedom vibration system comprising a first vibration system (a dynamic damper) in which a first mass member (a damper weight) is elastically supported by a first spring member (a viscoelastic member) and a second vibration system (a magnetostrictive power generation part) in which a second mass member (a magnetostrictive part weight) is elastically supported by a second spring member (a parallel beam). In JP-A-2014-011843, the second spring member which elastically connects the first mass member and the second mass member includes a magnetostrictive element serving as a power generating element, and through relative displacement of the first mass member and the second mass member during vibration input, vibration energy is configured to be converted to electrical energy by the power generating element.

Meanwhile, in vibration power generators, the resonance frequency of the first vibration system is generally tuned so as to roughly match the frequency of the main vibration of the vibrating member, so that the input vibration is configured to be amplified by resonance of the first vibration system and be transmitted to the second vibration system. This makes it possible to obtain a large amount of relative displacement between the first mass member and the second mass member in a resonant state, thereby increasing power generating efficiency. Note that in JP-A-2014-011843 as well, since the first vibration system comprises the dynamic damper that decreases vibration of the vibrating member (a base plate), it is apparent that the resonance frequency of the first vibration system roughly matches the frequency of the vibration of the vibrating member.

However, with the conventional vibration power generator as in JP-A-2014-011843, in the case where the vibration frequency of the vibrating member is a considerably higher frequency than the tunable range of the resonance frequency of the first vibration system, during input of vibration from the vibrating member to the first vibration system, it may be impossible for the first mass member and the second mass member to undergo a large relative displacement in a resonant state. This makes it difficult to obtain a sufficient amount of relative displacement between the first mass member and the second mass member, posing a risk of deterioration in power generating efficiency.

### SUMMARY OF THE INVENTION

The present invention has been developed in view of the above-described matters as the background, and it is an object of the present invention to provide a power generator with a novel structure which is able to generate electric power with a sufficiently high efficiency even in the case where the frequency of the input vibration is a higher frequency than the tunable range of the resonance frequency of the first vibration system.

The above and/or optional objects of this invention may be attained according to at least one of the following modes of the invention. The following modes and/or elements employed in each mode of the invention may be adopted at any possible optional combinations.

Specifically, a first mode of the present invention provides a power generator comprising: a first vibration system in which a first mass member is elastically supported by a first spring member; a second vibration system in which a second mass member is elastically supported by a second spring member, the second spring member elastically connecting the first mass member and the second mass member to each other so as to provide a multiple-degree-of-freedom vibration system; and a power generating element disposed between the first mass member and the second mass member, the first mass member being configured to be attached to a vibrating member by the first spring member so that vibration energy input to the first vibration system and the second vibration system from the vibrating member is converted to electrical energy by the power generating element, wherein a resonance frequency of the first vibration system is a frequency lower than 1/√2 times a frequency of a vibration input to the first vibration system from the vibrating member, and a loss factor of the first spring member of the first vibration system is at least 0.01 but not greater than 0.2.

With the first mode of the power generator constructed according to the present invention, even in the case where it is difficult to match the resonance frequency of the first vibration system with the vibration frequency of the vibrating member, it is possible to convert the vibration energy to the electrical energy so as to obtain sufficient electric power. Specifically, by setting the resonance frequency of the first vibration system to the frequency lower than 1/√2 times the vibration frequency of the vibrating member, the input from the vibrating member will substantially act on the first vibration system as a jarring load. As a result, the first vibration system undergoes self-induced resonance with respect to input from the vibrating member, so that the vibration will be effectively input to the second vibration system by resonance phenomenon of the first vibration system.

Moreover, the loss factor of the first spring member of the first vibration system is not greater than 0.2. Accordingly, vibration attenuation of the first vibration system caused by energy loss during elastic deformation of the first spring member will be reduced, so that vibration of the first vibration system continues over a relatively long period of time. As a result, vibration energy will be continuously input to the power generating element disposed between the first mass member and the second mass member, thereby obtaining a large power generation volume with respect to the load input.

Besides, the loss factor of the first spring member is at least 0.01, in addition to being not greater than 0.2. Thus, self-induced vibration of the first vibration system will take place with sufficiently broad frequency component, thereby broadening vibration to be input to the second vibration system (obtaining a wide-band frequency for which vibration of a sufficient level is input). By so doing, even if an error occurs in the resonance frequency of the second vibration system due to tolerance of the parts or the like, a stable input from the first vibration system to the second vibration system can be obtained in the resonance frequency of the second vibration system, thereby effectively achieving desired power generation volume while minimizing variability due to individual difference among the power generators. In addition, the resonance magnification of the first vibration system will be prevented from becoming greater any more than necessary, so as to limit the amount of deformation of the power generating element. This makes it possible to attain sufficient power generating efficiency as well as to ensure durability of the power generating element.

A second mode of the present invention provides the power generator according to the first mode, wherein a resonance frequency of the second vibration system is tuned to a range of at least 90% but not greater than 110% of the resonance frequency of the first vibration system.

According to the second mode, the resonance frequency of the first vibration system and the resonance frequency of the second vibration system are set to frequencies close to each other. With this arrangement, the second vibration system produces resonance phenomenon with respect to the self-induced vibration of the first vibration system, so as to be able to input sufficient vibration energy to the power generating element. Therefore, it is possible to enhance power generating efficiency of the power generating element disposed to the second vibration system, thereby obtaining a large amount of electric power by means of vibration power generation.

A third mode of the present invention provides the power generator according to the first or second mode, wherein a mass of the second mass member of the second vibration system is not greater than 20% of a mass of the first mass member of the first vibration system.

According to the third mode, the mass of the second mass member is made sufficiently smaller than the mass of the first mass member. Thus, by the second vibration system functioning as a dynamic damper with respect to the first vibration system, vibration damping effect applied to the first vibration system will be reduced. This will effectively produce self-induced vibration of the first vibration system, thereby obtaining a large vibration energy input to the power generating element.

A fourth mode of the present invention provides the power generator according to any one of the first through third modes, wherein the first spring member is a polymeric elastomer, and the second spring member is a metal spring.

According to the fourth mode, since the first spring member is a polymeric elastomer, it is possible to easily adjust the loss factor of the first spring member, so as to be able to readily obtain the first spring member depending on the purpose. Besides, the second spring member is a metal spring having a small loss factor. This will prevent vibration energy input to the power generating element from being decreased by energy attenuation effect due to elastic deformation of the second spring member, thereby realizing efficient power generation.

A fifth mode of the present invention provides the power generator according to any one of the first through fourth modes, wherein the first vibration system is configured to be attached to the vibrating member that inputs an intermittent jarring load to the first vibration system.

Even if the input from the vibrating member to the first vibration system is not continuous but intermittent as described in the fifth mode, the self-induced vibration of the first vibration system is produced over a certain duration of time, thereby making it possible to realize efficient power generation. Note that a jarring load may be a vibration load which can substantially be regarded as a jarring load when input to the first vibration system, which includes, for example, a high-frequency vibration that converges in a sufficiently short time with respect to the vibration cycle of the first vibration system, or the like.

According to the present invention, in the power generator including the first vibration system attached to the vibrating member and the second vibration system attached to the first vibration system, the resonance frequency of the first vibration system is a frequency lower than 1/√2 times the frequency of a vibration input to the first vibration system from the vibrating member, and the loss factor of the first spring member of the first vibration system is at least 0.01 but not greater than 0.2. By so doing, even in the case where it is difficult to match the resonance frequencies of the first and second vibration systems with the vibration frequency of the vibrating member, a sufficient vibration owing to the self-induced resonance of the first vibration system will be input to the second vibration system equipped with the power generating element over a certain duration of time, while reducing the differential of power generating efficiency with respect to deviation of the resonance frequency of the second vibration system. Thus, a highly efficient power generation will be realized with stability.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a vertical cross sectional view showing a power generator as a first embodiment of the present invention in a mounted state onto a vibrating member;

FIG. 2 is a vibration model showing a two-degree-of-freedom vibration system of the power generator shown in FIG. 1;

FIG. 3 is a graph showing the correlation between the frequency and the vibration level when handling each vibration system constituting the power generator shown in FIG. 1 as a one-degree-of-freedom vibration system;

FIGS. 4A and 4B are diagrams showing the relation between the input vibration and the power generation volume in the power generator shown in FIG. 1, wherein FIG. 4A shows the change in vibration level of the input vibration with respect to time, and FIG. 4B shows the change in power generation volume with respect to time; and

FIG. 5 is a vertical cross sectional view showing a power generator as a second embodiment of the present invention in a mounted state onto a vibrating member.

### DETAILED DESCRIPTION OF PREFERRED EMBODIMENTS

Embodiments of the present invention will be described below in reference to the drawings.

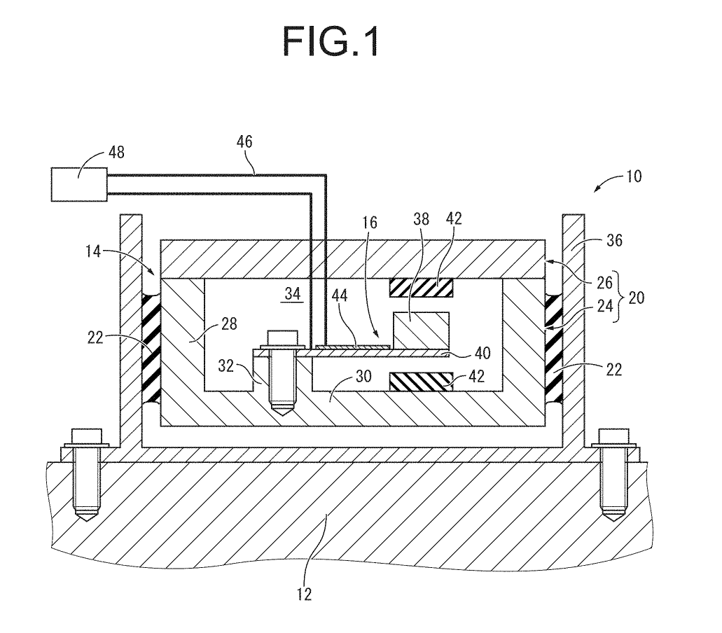

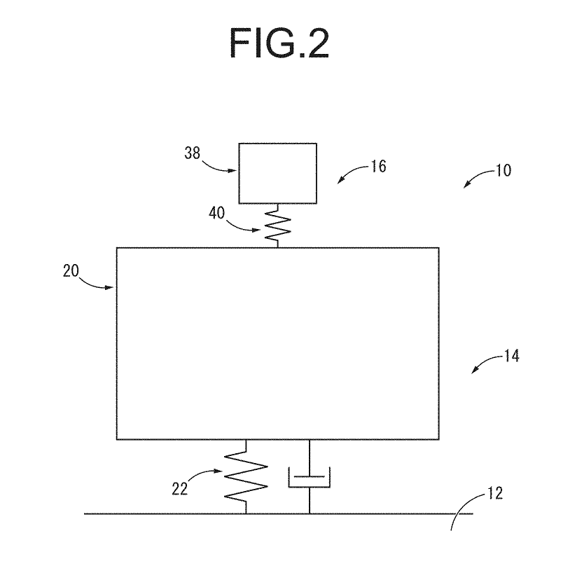

FIG. 1 depicts a power generator 10 as a first embodiment of the present invention. The power generator 10, as shown in a vibration model in FIG. 2 as well, is equipped with a multiple-degree-of-freedom vibration system that includes a first vibration system 14 configured to be attached to a vibrating member 12 and a second vibration system 16 configured to be attached to the vibrating member 12 via the first vibration system 14. In the description hereinbelow, unless otherwise noted, the vertical direction means the vertical direction in FIG. 1 which is the main vibration input direction of the vibrating member 12.

Described more specifically, the first vibration system 14 includes a first mass member 20 and a first spring member 22. The first mass member 20 is made of a material with a high specific gravity such as iron or the like, and has a hollow rectangular box shape wherein a lower mass 24 and an upper mass 26 are combined.

The lower mass 24 has a structure wherein a tubular peripheral wall 28 extending vertically is closed off at its lower opening by a bottom wall 30 integrally formed therewith, so as to have a bottomed tube shape opening upward overall. In addition, on the bottom wall 30 of the lower mass 24, there is integrally formed a support projection 32 projecting upward, with a screw hole opening onto its upper face. The upper mass 26 has a roughly flat plate shape, and has roughly the same contours as the peripheral wall 28 in top view. By the upper mass 26 being overlapped with the lower mass 24 so as to cover its opening and fixed to each other, the hollow first mass member 20 is formed by the lower mass 24 and the upper mass 26, with a housing space 34 formed inside.

Besides, the first mass member 20 is elastically supported by the first spring member 22. The first spring member 22 is an elastic body formed of a polymeric material such as rubber, resin elastomer or the like. In the present embodiment, the first spring member 22 is a rubber elastic body and is bonded by vulcanization to the outer peripheral surface of the peripheral wall 28 of the lower mass 24. Whereas the first spring member 22 may be continuously provided about the entire periphery in the peripheral direction, in the present embodiment, the first spring member 22 is provided at several locations in the peripheral direction.

Moreover, with the first spring member 22, the loss factor of energy is at least 0.01 but not greater than 0.2. The loss factor can be adjusted and set by the forming material of the first spring member 22 or the like. The first spring member 22 having the loss factor of the above-mentioned numerical range can be realized by, for example, a rubber and a resin elastomer having a small loss factor, or a metal having a large loss factor, or furthermore, a combination of a polymeric elastomer such as rubber having a large loss factor and a metal spring such as spring steel having a small loss factor, or the like. In the present embodiment, since the first spring member 22 is formed of a rubber elastic body, the loss factor is easily set within the above-mentioned numerical range. Note that with a metal spring formed of a general spring steel by itself, it is difficult to set the energy loss factor to the above-mentioned numerical range while tuning the resonance frequency f₁ of the first vibration system 14 appropriately for practical use. Thus, in the case where a metal spring is adopted by itself as the first spring member, it is suitable to select a metal spring formed of a metal material having a large loss factor such as magnesium or the like.

The first spring member 22 is secured to an attachment member 36 fixed by a bolt or the like to the vibrating member 12, so as to elastically connect the vibrating member 12 and the first mass member 20. The attachment member 36 is formed using a vertical wall structure spaced away from the first mass member 20 to the outer peripheral side, and the outer peripheral surface of the first mass member 20 is positioned in opposition to the attachment member 36 in the direction roughly orthogonal to the main vibration input direction. By the first spring member 22 being disposed between opposed faces of the outer peripheral surface of the first mass member 20 and the attachment member 36, the first mass member 20 is elastically supported by the attachment member 36. Then, by the attachment member 36 being fixed by bolting to the vibrating member 12, the first vibration system 14 is configured to be attached to the vibrating member 12. Note that the first spring member 22 is arranged to undergo shear deformation with respect to input in the main vibration input direction (the vertical direction in FIG. 1), and the shear spring component of the first spring member 22 is configured to act as a main spring of the first vibration system 14.

Moreover, the second vibration system 16 is housed within the housing space 34 of the first mass member 20. The second vibration system 16 includes a second mass member 38 and a second spring member 40, and the second mass member 38 is elastically connected to the support projection 32 via the second spring member 40 in the housing space 34 of the first mass member 20.

The second mass member 38 is preferably formed of a high gravity material such as iron or the like, and has a solid pillar shape or block shape. The second spring member 40 is a plate spring formed of a spring steel or the like, and is deformable in an elastic manner vertically in the thickness direction. Besides, the loss factor of the second spring member 40 is set lower than that of the first spring member 22, and preferably set lower than 0.01. Then, the basal end portion of the second spring member 40 is fixed by a screw or the like to the support projection 32 of the first mass member 20, while to the distal end portion of the second spring member 40, the second mass member 38 is fixed by means of bonding, welding, screwing, mechanical engagement or the like. Accordingly, the second mass member 38 is connected to the first mass member 20 in a condition such that vertical displacement is allowed. By so doing, the second vibration system 16 is attached to the first vibration system 14 so as to constitute a two-degree-of-freedom vibration system.

With the second vibration system 16 attached to the first vibration system 14, the second mass member 38 is remote from and opposed to both of the bottom wall 30 of the lower mass 24 and the upper mass 26 of the first mass member 20 in the vertical direction. Additionally, stopper rubbers 42 are disposed in the respective upper and lower spaces between opposed faces of the second mass member 38 and the first mass member 20. With this arrangement, even when the second spring member 40 undergoes an excessive elastic deformation, the second mass member 38 is prevented from directly striking the first mass member 20, thereby avoiding occurrence of striking noises.

Furthermore, a power generating element 44 is secured to the second spring member 40 that connects the first mass member 20 and the second mass member 38. As the power generating element 44, it is possible to adopt various types of elements capable of converting vibration energy to electrical energy, and for example, a piezoelectric element, a magnetostrictive element or the like can be adopted. In the present embodiment, a piezoelectric element is adopted as the power generating element 44, and is overlapped and secured to the upper face of the second spring member 40. By so doing, the piezoelectric element deforms due to bending deformation of the second spring member 40 in the thickness direction, and is capable of energy conversion action owing to direct piezoelectric effect. Note that in the case where the piezoelectric element is adopted as the power generating element 44, ceramic material, monocrystalline material or the like may be used as the forming material, for example. More specifically, for example, any of lead zirconate titanate, aluminum nitride, lithium tantalate, lithium niobate or the like can be preferably used as the forming material for the piezoelectric element.

This power generating element 44 is connected to an electrical circuit 46. Through the electrical circuit 46, the power generating element 44 is electrically connected to a device 48, which is a power using device such as a rectifier circuit, a power storage device, various types of sensors, a wireless communication device, or the like. Accordingly, generated electric power of the power generating element 44 described later is configured to be supplied to the device 48.

With the power generator 10 of the above construction mounted onto the vibrating member 12, vibration will be input from the vibrating member 12 to the power generator 10, and the input vibration energy is configured to be converted to electrical energy and extracted by the power generating element 44. In the present embodiment, vibration to be input from the vibrating member 12 to the power generator 10 is such that a frequency f₀ is on the order of 500 Hz, and is configured to be input intermittently at specified time intervals. As such intermittent vibration, in the case where the vibrating member 12 is a road, a bridge, a railroad track or the like composed of units divided by a prescribed length being jointed, a load input by a vehicle passing the joints is a conceivable example.

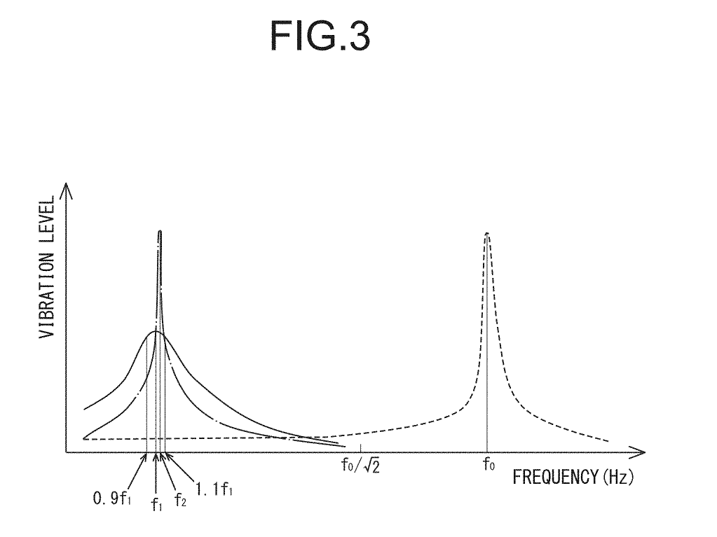

Also, as shown in FIG. 3, a resonance frequency f₁ of the first vibration system 14 is a frequency lower than 1/√2 times the frequency f₀ of vibration to be input from the vibrating member 12 to the first vibration system 14, and in the present embodiment, the resonance frequency f₁ is set to on the order of 100 Hz. As is generally known, the resonance frequency f₁ of the first vibration system 14 is set by adjusting the mass of the first mass member 20 and the spring constant of the first spring member 22. Note that in FIG. 3, the characteristics of the vibration level and the frequency are indicated by the solid line for the first vibration system 14, by the dot-and-dash line for the second vibration system 16, and by the dashed line for the input vibration from the vibrating member 12.

Moreover, in the present embodiment, the resonance frequency f₁ of the first vibration system 14 and a resonance frequency f₂ of the second vibration system 16 are set to roughly the same frequency with each other. More specifically, the resonance frequency f₂ of the second vibration system 16 is set to a range of 0.9 to 1.1 times the resonance frequency f₁ of the first vibration system 14. By so doing, the resonance phenomenon of the second vibration system 16 is configured to be produced in the frequency range for which a sufficiently large vibration level can be obtained in the self-induced vibration of the first vibration system 14. In the present embodiment, since the resonance frequency f₁ of the first vibration system 14 is tuned to on the order of 100 Hz, it is desirable to set the resonance frequency f₂ of the second vibration system 16 to a range of 90 to 110 Hz. As is generally known, the resonance frequency f₂ of the second vibration system 16 is set by adjusting the mass of the second mass member 38 and the spring constant of the second spring member 40.

In addition, the mass of the second mass member 38 of the second vibration system 16 is not greater than 20% of the mass of the first mass member 20, so as to be lighter than the first mass member 20. In more preferred practice, by the mass of the second mass member 38 being at least 5% of the mass of the first mass member 20, it becomes easy to tune the resonance frequency of the second vibration system 16 to a frequency range close to the resonance frequency of the first vibration system 14.

Here, the high-frequency vibration of 500 Hz input from the vibrating member 12 to the power generator 10 converges in a considerably short time with respect to the vibration cycle of the first vibration system 14 which is tuned to a sufficiently lower frequency than that of input vibration, so that such high-frequency vibration substantially acts as a jarring load on the first vibration system 14. By so doing, the first vibration system 14 produces self-induced vibration due to input from the vibrating member 12, and the first mass member 20 displaces in a resonant state. Then, by the self-induced vibration of the first vibration system 14 being transmitted and input to the second vibration system 16, a mass-spring resonance of the second vibration system 16 will be produced, whereby the power generating element 44 attached to the second spring member 40 of the second vibration system 16 deforms in the thickness direction. As a result, the direct effect of the piezoelectric conversion action of the power generating element 44 produces vibration power generation that converts vibration energy to electrical energy, thereby supplying the electrical energy to the device 48 through the electrical circuit 46.

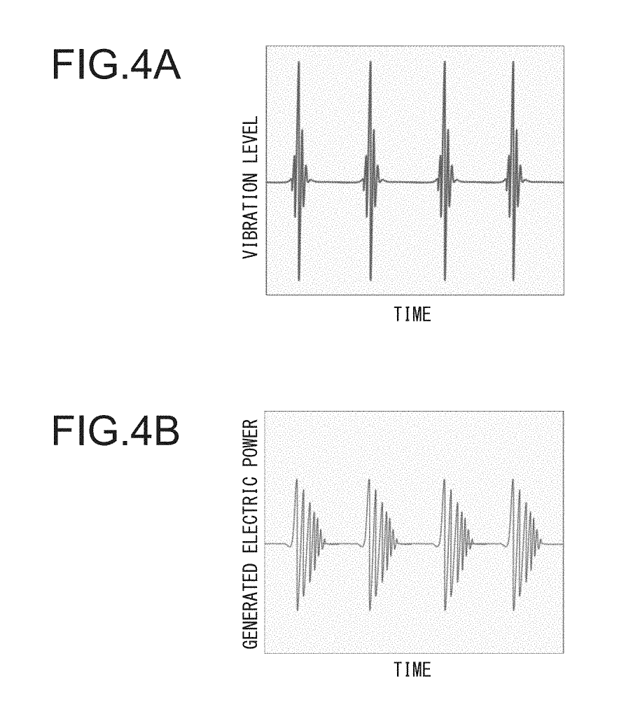

Furthermore, since the loss factor of the first spring member 22 is set sufficiently small, namely, not greater than 0.2, it is possible to inhibit the vibration energy input to the power generating element 44 from being decreased due to energy attenuation action that occurs during elastic deformation of the first spring member 22. Therefore, as shown in FIG. 4, in the first vibration system 14, the vibration state for a single input continues longer with respect to the time of input, so that the vibration energy will be efficiently input to the power generating element. Note that in the present embodiment, the second spring member 40 is a metal spring formed of a general spring steel, whose loss factor is extremely small. This makes it possible to prevent the vibration energy from being decreased due to energy attenuation action of the second spring member 40, thereby advantageously obtaining input to the power generating element 44.

In this way, with the power generator 10 according to the present invention, even in the case where the frequency of the vibration input from the vibrating member 12 to the power generator 10 is such a high frequency that matching the resonance frequencies of the vibration systems 14, 16 in the power generator 10 is difficult, the self-induced vibration of the first vibration system 14 enables the vibration energy to effectively act on the power generating element 44, thereby realizing power generation with sufficiently high efficiency. In particular, in the case where the vibration input from the vibrating member 12 to the power generator 10 is a vibration in which short-time inputs, each of which can be regarded as a jarring load, are intermittently repeated, the vibration state of the first vibration system 14 for each input continues sufficiently longer with respect to the time of input, so that excellent power generating efficiency will be attained. As a specific example, even in the aforementioned case where high-frequency vibrations are intermittently induced under a high rigidity of the road structure due to the jarring load of the passing vehicle which is repeatedly applied to the joints or the like of the bridge or overpass of the road, such inputs of high-frequency vibration make it possible to effectively exhibit power generation action based on vibration of the second vibration system 16 of the power generator 10.

Also, with the power generator 10 of the present embodiment, the resonance frequency f₂ of the second vibration system 16 is set so as to roughly match the resonance frequency f₁ of the first vibration system 14, whereby the self-induced vibration of the first vibration system 14 is configured to be efficiently amplified owing to the resonance of the second vibration system 16. Accordingly, a large vibration magnification of the second vibration system 16 can be obtained with respect to the input vibration from the first vibration system 14, thereby realizing high power generating efficiency.

Note that as the resonance frequency f₂ of the second vibration system 16 becomes away from the resonance frequency f₁ of the first vibration system 14, the vibration magnification of the second vibration system 16 becomes smaller so that the amount of deformation of the second spring member 40 decreases. Therefore, in order to avoid damage to the second spring member 40 due to its excessive deformation and ensure its durability while obtaining sufficient power generating efficiency, it is desirable to suitably adjust the differential between the resonance frequency f₂ of the second vibration system 16 and the resonance frequency f₁ of the first vibration system 14. As is apparent from the above description, in the case where it is difficult to ensure durability of the second spring member 40 or the like, it would also be acceptable to set the resonance frequency f₂ of the second vibration system 16 to a high frequency that is away from the range of 0.9 to 1.1 times the resonance frequency f₁ of the first vibration system 14. Moreover, in the case where the power generation volume is greater any more than necessary or the like, similarly, by setting the resonance frequency f₂ of the second vibration system 16 away from the resonance frequency f₁ of the first vibration system 14, it would also be possible to decrease input to the second spring member 40 so as to realize compactization of the second spring member 40.

Furthermore, the mass of the second mass member 38 of the second vibration system 16 is not greater than 20% of the mass of the first mass member 20 of the first vibration system 14. Thus, vibration damping effect applied from the second vibration system 16 to the first mass member 20 will be sufficiently decreased. Therefore, the self-induced vibration of the first vibration system 14 will be sufficiently produced without being decreased by the second vibration system 16, thereby efficiently inputting vibration energy to the power generating element 44 of the second vibration system 16.

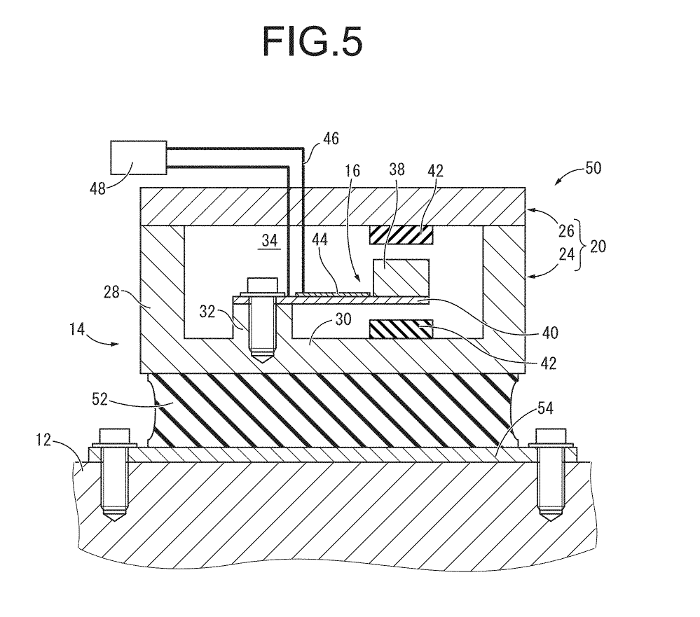

FIG. 5 depicts a power generator 50 according to a second embodiment of the present invention. In the power generator 50, a first spring member 52 that constitutes the first vibration system 14 is a compression spring. In the following description, components and parts that are substantially identical with those in the first embodiment will be assigned like symbols and not described in any detail.

Specifically, the first spring member 52 is bonded by vulcanization to the lower face of the bottom wall 30 of the lower mass 24 that constitutes the first mass member 20, while being bonded by vulcanization to an attachment member 54 that is arranged in opposition to the bottom wall 30, thereby elastically connecting the first mass member 20 and the attachment member 54 in the vertical direction. By this attachment member 54 being fixed by bolting to the vibrating member 12, the first vibration system 14 is attached to the vibrating member 12, so that the power generator 50 is configured to be attached to the vibrating member 12.

With the power generator 50 constructed according to the present embodiment as well, similarly to the power generator 10 of the first embodiment, a high-frequency vibration input from the vibrating member 12 will be amplified by self-induced vibration of the first vibration system 14 and continuously transmitted to the second vibration system 16 over a certain period of time. Thus, efficient power generation is realized.

Moreover, since the first spring member 52 deforms primarily in the directions of compression and tension with respect to vibration input from the vibrating member 12, durability will be more easily ensured in comparison with the case where shear deformation predominates.

While the present invention has been described in detail hereinabove in terms of the preferred embodiments, the invention is not limited by the specific disclosures thereof. For example, the power generating element is not limited to the piezoelectric element shown in the preceding embodiments, but for example, a magnetostrictive element or the like may be adopted.

Whereas the preceding embodiments exemplified a two-degree-of-freedom vibration system including the first vibration system 14 and the second vibration system 16, the present invention may also be implemented in a multiple-degree-of-freedom vibration system of three degrees of freedom or greater.

Besides, any of the first spring member 22 and the second spring member 40 illustrated in the preceding embodiments is merely exemplary. For example, the first spring member 22 may be a metal spring, and the second spring member 40 may be formed by a polymeric elastomer.

Furthermore, the present invention is not necessarily limited to the structure in which the second vibration system 16 is housed within the housing space 34 of the first mass member 20, but the second vibration system 16 may be attached to the outside of the first mass member 20. In this case, the first mass member 20 does not need to be a hollow structure, but may be a solid structure so as to obtain a required mass of the mass member while achieving compactization.

What is claimed is:

1. A power generator comprising:
a first vibration system in which a first mass member is elastically supported by a first spring member;
a second vibration system in which a second mass member is elastically supported by a second spring member, the second spring member elastically connecting the first mass member and the second mass member to each other so as to provide a multiple-degree-of-freedom vibration system; and
a power generating element disposed between the first mass member and the second mass member, the first mass member being configured to be attached to a vibrating member by the first spring member so that vibration energy input to the first vibration system and the second vibration system from the vibrating member is converted to electrical energy by the power generating element, wherein
a resonance frequency of the first vibration system is a frequency lower than 1/√2 times a frequency of a vibration input to the first vibration system from the vibrating member, and
a loss factor of the first spring member of the first vibration system is at least 0.01 but not greater than 0.2.

2. The power generator according to claim 1, wherein a resonance frequency of the second vibration system is tuned to a range of at least 90% but not greater than 110% of the resonance frequency of the first vibration system.

3. The power generator according to claim 1, wherein a mass of the second mass member of the second vibration system is not greater than 20% of a mass of the first mass member of the first vibration system.

4. The power generator according to claim 1, wherein the first spring member is a polymeric elastomer, and the second spring member is a metal spring.

5. The power generator according to claim 1, wherein the first vibration system is configured to be attached to the vibrating member that inputs an intermittent jarring load to the first vibration system.
